(19) United States
(12) Patent Application Publication
(10) Pub. No.: US 2002/0044745 A1
(43) Pub. Date: Apr. 18, 2002

(54) Method of aligning an optical component with an inclined guide mounted on a base and the associated optical device

(75) Inventors: Bruno Fernier, Bourg-La-Reine (FR); Dominique Keller, Fontenay-Les-Buiis (FR); Stephane Rabaron, Fontenay-dux-Roses (FR); Alwin Goth, Altensteig (DE)

Correspondence Address: SUGHRUE, MION, ZINN, MACPEAK & SEAS, PLLC, 2100 Pennsylvania Avenue, NW, Washington, DC, 20037-3213, US

(73) Assignee: ALCATEL

(21) Appl. No.: 09/866,674

(22) Filed: May 30, 2001

(30) Foreign Application Priority Data
May 31, 2000 (FR) 0007043

(51) Int. Cl. G02B 6/30; G02B 6/26

(52) U.S. Cl. 385/52; 385/49

(57) ABSTRACT

The invention concerns an optical device having an optical component (1) disposed on a base (5) provided with support elements (20), the component having a waveguide (12) and an exit facet (15) situated in a plane perpendicular to the plane of assembly of the component on the base, the said facet being inclined with respect to the plane perpendicular to the axis (11) of the waveguide, an optical wave issuing from the component then propagating in an intermediate medium along an optical exit beam axis (30), characterised in that the optical component has support elements (18) complementary to those (20) of the base and which cooperate with the latter for lateral positioning (x), and in that the complementary support elements (18, 20) are disposed so as not to modify the direction of the said optical axis (30) of the exit beam during a longitudinal movement (z) of the component on the base.

The present invention relates to a method of aligning optical components disposed on a base, such as a silicon support for example, and to the associated optical device. The invention concerns more specifically such a method and device comprising at least one optical component having a waveguide and an exit facet whose plane is perpendicular to the plane of the base and inclined with respect to the plane perpendicular to the direction of the waveguide. Such a component is also known as an inclined-guide component, or “tilted”.

One of the main problems which it is in general sought to resolve in integrated optics consists in effecting an optimum optical mode coupling between the different components of the device separated by an intermediate medium (air, polymer or other). However, given the size of the modes used for optical information transmissions, an optimum coupling necessarily depends on a precise alignment of the optical axes of the components with the beam of the optical wave propagating in the intermediate medium. In the case of non-tilted components, this exit beam of the optical wave will be parallel to the optical axes of the components.

Thus, the optical coupling of a laser with an optical fibre, for example, requires a vertical and lateral alignment of the two components so as to make the optical axes coincide, and a longitudinal adjustment for optimising the coupling power.

Several methods of aligning components on a base are known from the state of the art.

A first method consists in effecting an active or dynamic alignment by means of a real-time measurement of the power of the optical signal emitted in the fibre. This method makes it possible to obtain good results from the qualitative point of view (precision less than 1 μm) but in no way fits within a logic of manufacturing low-cost integrated devices.

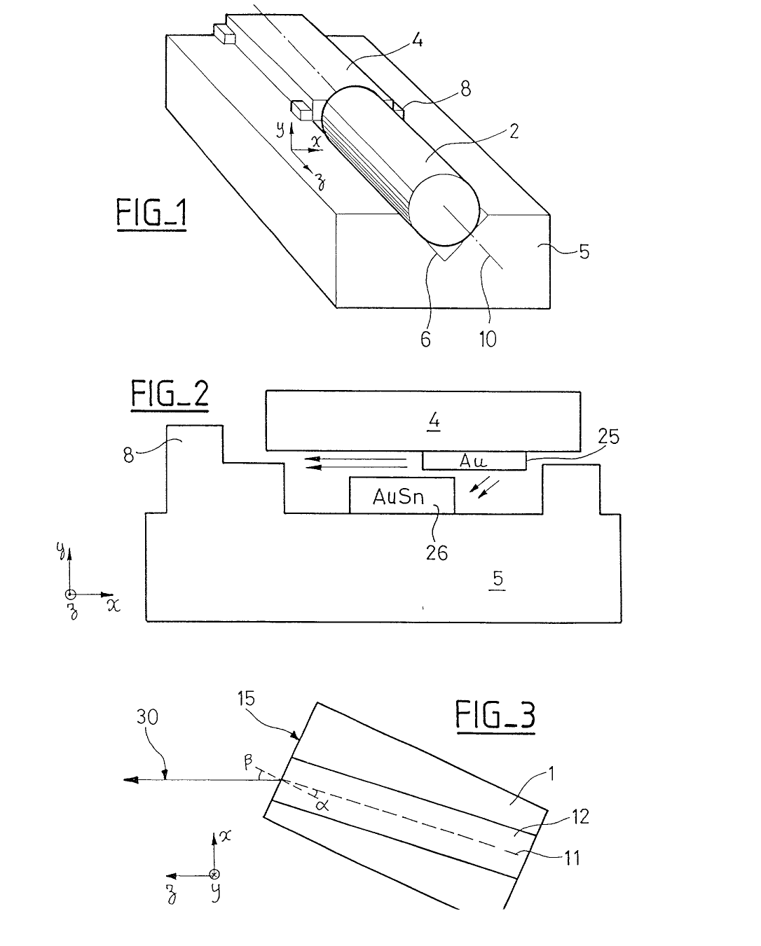

Another method, known as passive alignment, is illustrated in FIG. 1, which depicts a schematic perspective view of a laser chip 4 and an optical fibre 2 both aligned on a base 5, their optical axes 10 being merged.

The optical fibre 2 is placed on the base 5 in a V-shaped groove 6 which positions it laterally (along the x-axis) and vertically (along the y-axis). The laser chip 4 is placed on the base 5 by a machine whose precision is around 5 μm approximately. This precision is well below that obtained by an active alignment and is not sufficient in the context of applications to optical information transmission. A better lateral positioning of the laser chip on the base 5 can then be obtained by placing the chip 4 against stops 8 formed on the base 5.

Putting the laser chip 4 in abutment on the base 5 can be achieved by a method of fusing a metallisation and soldering, also known by the term “Reflow Process”. Such a method, well mastered in the state of the art, is illustrated in FIG. 2.

The chip 4 is covered with a gold (Au) metallisation 25 and the base 5 is covered with a metallisation supporting a gold/tin (AuSn) solder 26. The respective shapes and locations of the two metallisations 25, 26 are controlled precisely. Heating is then carried out, and the fusion of the two metallisations 25, 26 generates a restoring force by capillary attraction effect which presses the chip 4 against the base (vertical alignment along y) and returns it against the stops 8 (lateral alignment along x).

The longitudinal position (along z) of the components is optimised by causing one or other component to slide in this direction, by moving the fibre 2 in the groove 6 for example. The coupling losses on the longitudinal position are in fact minute in comparison with the optical losses incurred through a poor lateral or vertical positioning of the components.

This passive alignment method affords a precise lateral positioning of a component 4 on a base 5.

The problem does however entirely persist in the case of tilted components 1 disposed on a base 5 (FIG. 3). This is because, in order to reduce the reflectivity of the exit facet 15 of an optical component 1, a laser made from III-V semiconductor material for example, a waveguide 12 is produced in the assembly plane of the component but where the direction of the optical axis 11 is tilted by an angle α (of 7° for example) with respect to the perpendicular to the plane of the exit facet 15. The exit facet 15 can be etched or cleft along one of the crystalline planes of the semiconductor material (InP for example), these two techniques being well mastered in the prior art.

According to one particularity of these tilted components, the optical wave coming from the waveguide 12 and propagating outside the component 1 in an intermediate medium defines an optical exit beam axis 30 which is not perpendicular to the exit facet 15 of the component 1. This particularity results directly from the application of Descarte's law.

The alignment of such a tilted component with another component, tilted or not, on a base consequently becomes very tricky since the least longitudinal movement may compromise the lateral alignment and cause significant coupling losses.

Machines make it possible to effect such an alignment with the required precision of around 1 micrometer. However, these means are expensive and take a long time to adjust, which does not fit within a logic of the mass production of optical devices comprising tilted components.

The objective of the present invention is to allow an alignment of components, where at least one is a tilted component, on a base.

The present invention uses the technique of “Reflow Process” and applies it to an optical device comprising a tilted component.

To this end, the invention proposes to produce complementary mechanical supports on the base and on the tilted component, these supports being disposed so as not to modify the direction of the optical axis of the exit beam during any longitudinal movement of the component on the base.

The orientation of the complementary mechanical supports is such that the common axes of these supports is parallel to the axis of the beam of the optical wave propagating in the intermediate medium.

The present invention relates more particularly to a method of alignment on a base of an optical component having a waveguide situated in a plane parallel to the assembly plane of the component on the base and an exit facet situated in a plane perpendicular to the assembly plane of the component, the said facet being inclined with respect to the plane perpendicular to the axis of the waveguide, an optical wave issuing from the component then propagating along an optical exit beam axis, characterised in that it includes the following steps:

producing support elements on the base;

producing support elements on the optical component, these elements being complementary to those produced on the base, the said support elements on the component and on the base being disposed so as not to modify the direction of the said optical axis during a longitudinal movement of the component on the base;

laterally aligning the component on the base by putting the complementary support elements in abutment.

According to one characteristic, the base is on a silicon substrate.

According to another characteristic, the optical component is a semiconductor component made from III-V material.

According to one embodiment, the support elements on the base and component are produced by dry etching.

According to another embodiment, the support elements on the component are produced by chemical etching.

According to one characteristic, the putting of the complementary support elements in abutment is effected by means of gold metallisation and gold/tin solder deposited respectively on the component and on the base, or vice-versa, so as to enable a lateral restoring force to be exerted between the component and the base by means of heating.

The present invention also concerns an optical device having at least one optical component disposed on a base, support elements being provided on the said base, the component having a waveguide situated in a plane parallel to the plane of assembly of the component on the base and an exit facet situated in a plane perpendicular to the plane of assembly of the component on the base, the said facet being inclined with respect to the plane perpendicular to the axis of the waveguide, an optical wave issuing from the component then propagating in an intermediate medium along an optical exit beam axis, characterised in that the optical component has support elements complementary to those on the base and which cooperate with the latter for lateral positioning of the component on the base, and in that the complementary support elements of the component and base are disposed so as not to modify the direction of the said optical axis of the exit beam when there is a longitudinal movement of the component on the base.

According to a variant, the intermediate medium is air.

According to another variant, the intermediate medium is a polymer.

According to one application, the component is aligned on the base with an optical fibre.

According to another application, the component is aligned on the base with one or more silica guides, the component having a length controlled for alignment with a plurality of silica guides.

According to one application, the optical component is an optical signal emitter.

According to another application, the optical component is an optical signal emitter/receiver.

The particularities and advantages of the invention will emerge from a reading of the following description, given by way of illustrative and non-limitative example, and made with reference to the accompanying figures, which depict:

FIG. 1, already described, schematically illustrates a conventional technique of aligning a laser chip with an optical fibre on a silicon base;

FIG. 2, already described, schematically illustrates the technique of lateral alignment by fusion;

FIG. 3, already described, schematically illustrates a tilted component;

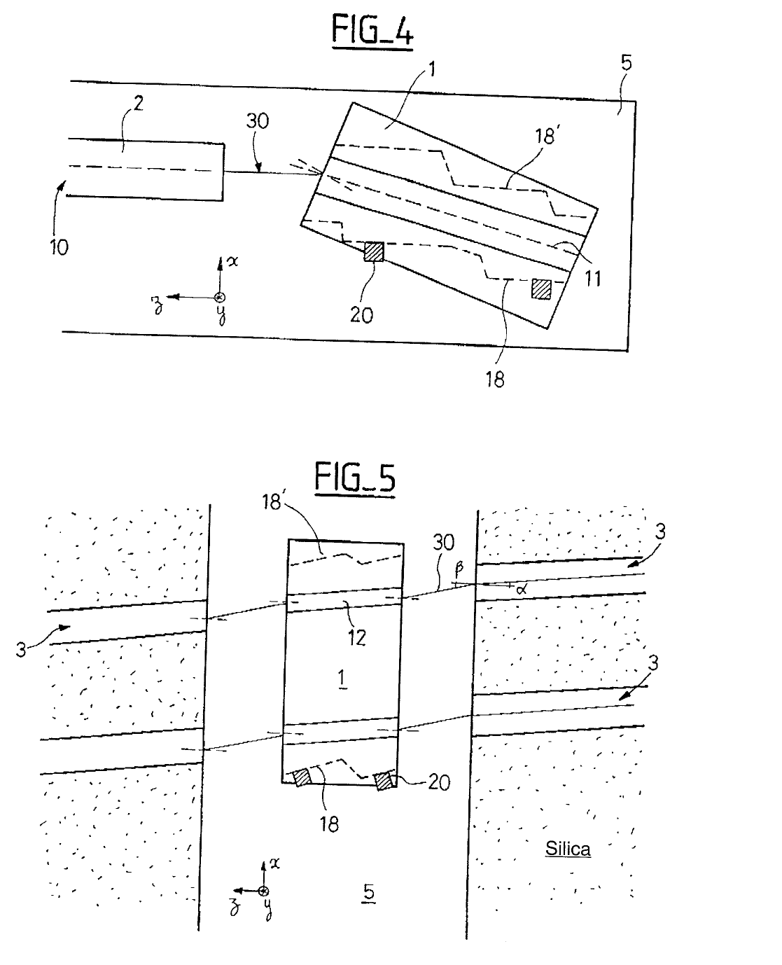

FIG. 4 is a schematic plan view of the optical device according to a first application of the invention;

FIG. 5 is a schematic plan view of the optical device according to a second application of the invention;

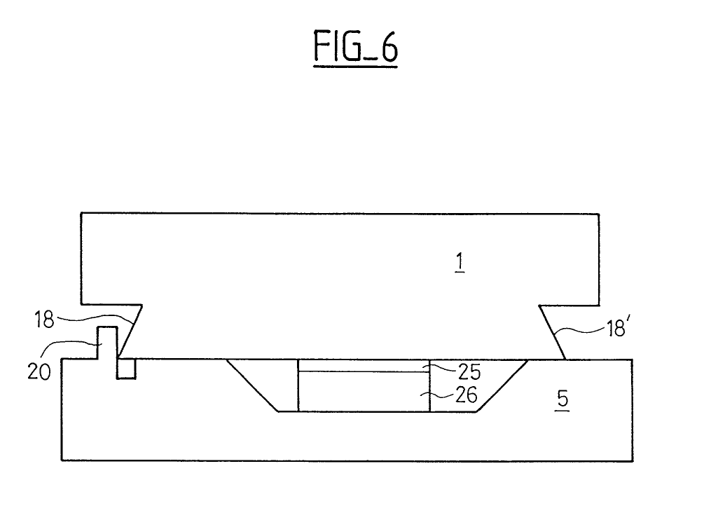

FIG. 6 is a schematic view in section of the optical device according to the invention.

The present invention sets out to produce an optical device having at least one tilted component, such as a laser chip on InP, for example, the said component being disposed on a silicon base and aligned so as to allow optimum optical coupling with another component, such as an optical fibre or silica guides for example.

The use of a tilted component advantageously makes it possible to minimise the reflectivity of its exit facet from approximately 0.3% for a straight cleft facet in InP to a value of less than 0.1% for a cleft and tilted facet. Such a component has an inclined waveguide 12, situated in a plane parallel to the plane of assembly of the component 1 on the base 5, and an exit facet 15, situated in a plane perpendicular to the plane of assembly of the component 1 on the base 5, and inclined with respect to the plane perpendicular to the axis 11 of the waveguide 12. The optical wave issuing from the component 1 then propagates along an optical exit beam axis 30 which is not perpendicular to the plane of the exit facet 15.

The purpose of the invention is to effect an optical coupling which is not compromised by a longitudinal movement of the components with respect to each other on the base.

FIG. 4 illustrates a first application of the invention in which a tilted optical component 1 is aligned with an optical fibre 2 on a base 5. The optical fibre 2 is advantageously positioned on the base 5 in a V-shaped groove, as is well known from the prior art. The tilted component 1 is placed on the base 5 by means of a conventionally used machine, which positions it to within ±5 μm.

The objective of the invention is to position the tilted component 1 precisely on the base 5 (a precision better than one micrometer is sought) so as to align the optical axis 30 of the exit beam with the optical axis 10 of the fibre 2. This alignment affords on the one hand an optimum coupling of the optical modes, and on the other hand an adjustment of the distance separating the components 1 and 2. The longitudinal adjustment (along z) can be obtained, for example, by a movement of the optical fibre 2 in its groove, as is known from the prior art.

The positioning of the tilted component 1 on the base 5 is obtained by means of mechanical support elements 18 and 20 produced respectively on the component 1 and on the base 5, these elements 18 and 20 being complementary and disposed parallel to the optical axis 30 of the exit beam so as not to modify the direction of the said axis 30 during any longitudinal movement, along z, of the component 1 on the base 5.

The support elements 20 on the base 5 can be stops produced by dry etching, for example, as is often done for positioning non-tilted components 4 in the prior art.

The support elements 18 of the component 1 can be indentations produced by dry etching or by chemical etching along a defined crystalline plane of the component 1. In the case of chemical etching, indentations 18 and 18′ will be obtained on each side of the component 1 even if only one series of indentations 18 is necessary for the lateral alignment of the component on the base.

Putting these complementary support elements 18 and 20 in abutment can advantageously be effected by means of a gold (Au) metallisation 25 and a gold/tin solder (AuSn) 26 deposited respectively on the component 1 and on the base 5 (or vice-versa) so as to enable a lateral and vertical restoring force to be exerted by heating according to the known technique of “Reflow Process”.

FIG. 5 illustrates a second application of the invention in which a tilted optical component 1 is aligned with silica guides 3 on a base 5. The silica guides 3 are buried and can advantageously have straight or tilted facets. The tilted component 1 is placed on the base 5 by means of a conventionally used machine which positions it to within ±5 μm.

In this application, the component 1 must on the one hand be positioned on the base 5 with a precision of around one micrometer, and on the other hand possibly be moved in the longitudinal direction (along z) for an adjustment of the coupling power without for all that compromising the lateral alignment (along x) of the components 1 and 3. The silica guides 3 are in fact fixed in their position on the base 5.

To this end, complementary support elements 18 and 20 are produced respectively on the component 1 and on the base 5 as described with reference to the first application. The orientation of these support elements 18 and 20 is such that the direction of the optical axis 30 of the optical wave propagation beam in the intermediate medium (air, polymer or other) is not modified by any longitudinal movement of the component 1 on the base 5. This direction 30 of propagation of the optical wave in the intermediate medium is determined by perfectly mastered mathematical techniques which stem directly from the application of Descarte's law.

It is thus possible to cause the component 1 to slide slightly on the base 5 for adjustment of the coupling without compromising its quality through a lateral shift.

According to the invention, the tilted component can function as an optical signal emitter, or as an optical signal receiver/emitter.

1. A method of alignment on a base (5) of an optical component (1) having a waveguide (12) situated in a plane parallel to the assembly plane of the component (1) on the base (5) and an exit facet (15) situated in a plane perpendicular to the assembly plane of the component (1) on the base (5), the said facet (15) being inclined with respect to the plane perpendicular to the axis (11) of the waveguide (12), an optical wave issuing from the component (1) then propagating along an optical exit beam axis (30), characterised in that it includes the following steps:
producing support elements (20) on the base (5);
producing support elements (18) on the optical component (1), these elements (18) being complementary to those (20) produced on the base (5), the said support elements (18, 20) on the component (1) and on the base (5) being disposed so as not to modify the direction of the said optical axis (30) during a longitudinal movement of the component (1) on the base (5);
laterally aligning the component (1) on the base (5) by putting the complementary support elements (18, 20) in abutment.

2. A method according to claim 1, characterised in that the base (5) is on a silicon substrate.

3. A method according to claim 1 to 2, characterised in that the optical component (1) is a semiconductor component made from III-V material.

4. A method according to any one of the preceding claims, characterised in that the support elements (18, 20) on the base (5) and on the component (1) are produced by dry etching.

5. A method according to one of claims 1 to 3, characterised in that the support elements (18) on the component (1) are produced by chemical etching.

6. A method according to any one of the preceding claims, characterised in that the putting of the complementary support elements (18, 20) in abutment is effected by means of gold metallisation (25) and gold/tin solder (26) deposited respectively on the component (1) and on the base (5), or vice-versa, so as to enable a lateral restoring force to be exerted between the component (1) and the base (5) by means of heating.

7. An optical device having at least one optical component (1) disposed on a base (5), support elements (20) being provided on the said base (5), the component having a waveguide (12) situated in a plane parallel to the plane of assembly of the component (1) on the base (5) and an exit facet (15) situated in a plane perpendicular to the plane of assembly of the component (1) on the base (5), the said facet (15) being inclined with respect to the plane perpendicular to the axis (11) of the waveguide (12), an optical wave issuing from the component (1) then propagating in an intermediate medium along an optical exit beam axis (30), characterised in that the optical component (1) has support elements (18) complementary to those (20) on the base (5) and which cooperate with the latter for lateral positioning (x) of the component (1) on the base (5), and in that the complementary support elements (18, 20) of the component (1) and base (5) are disposed so as not to modify the direction of the said optical axis (30) of the exit beam when there is a longitudinal movement (z) of the component (1) on the base (5).

8. An optical device according to claim 7, characterised in that the intermediate medium is air.

9. An optical device according to claim 7, characterised in that the intermediate medium is a polymer.

10. An optical device according to any one of claims 7 to 9, characterised in that the component (1) is aligned on the base (5) with an optical fibre (2).

11. An optical device according to any one of claims 7 to 9, characterised in that the component (1) is aligned on the base (5) with one or more silica guides (3), the component (1) having a controlled length for alignment with a plurality of silica guides (3).

12. An optical device according to any one of claims 7 to 11, characterised in that the optical component (1) is an optical signal emitter.

13. An optical device according to any one of claims 7 to 11, characterised in that the optical component (1) is an optical signal emitter/receiver.
